(19) United States
(12) Patent Application Publication
(10) Pub. No.: US 2004/0099493 A1
(43) Pub. Date: May 27, 2004

(54) Lining, in particular friction lining for disc brakes

(76) Inventors: Rainer Himmelsbach, Dassendorf (DE); Hansjorg Grimme, Karwitz/Nausen (DE)

Correspondence Address: Friedrich Kueffner, 317 Madison Avenue, Suite 910, New York, NY, 10017, US

(21) Appl. No.: 10/312,666

(22) PCT Filed: Jul. 4, 2001
(86) PCT No.: PCT/EP01/07644

(30) Foreign Application Priority Data
Jul. 5, 2000 (DE) 200 11 435.2

(51) Int. Cl. F16D 69/00

(52) U.S. Cl. 188/250 B

(57) ABSTRACT

The lining or functional body (10) consists a carrier (11) in form of a ground plate, for example a carrier plate or a carrier sheet, of a thin-walled rough ground carrier (15; 15′) made of a metal sheet or of another appropriate material placed on the carrier (11; 11′), of a rough ground (20′) made of a support base (20; 20′; 21) sintered on the surface (15a; 15′a) of the rough ground carrier (15; 15′) which is turned away from the lining carrier (11; 11′), this support base being made of single moulded bodies (22′) with undercuts, recesses or the like which are positively and frictionally connected with the rough ground carrier (15; 15′), and of a functional block (25; 25′) fixed on the rough ground carrier (15; 15′) with the rough ground (20′), this functional block being made of a friction material, a synthetic material, in particular of such a synthetic material which is not appropriate to be glued together or to be applied in another manner, for example of a polymer or teflon, whereby the rough ground carrier (15; 15′) is fixed on the lining carrier (11; 11′) by means of a welded, riveted or glued joint (30; 30′) or other connecting procedures, such as engraving.

### FIELD OF APPLICATION

This invention relates to a lining or a functional body or a friction lining for disk brakes, in particular for high-performance brakes for road and rail vehicles, according to the preamble of the claims 1 and 2.

### PRIOR ART

Friction linings for disk brakes according to the preamble of the claims 1 and 2 are known.

### AIM, SOLUTION, ADVANTAGE

The aim of this invention is to create a lining or a functional body or a friction lining for disk brakes of the above mentioned type with which the strength properties of carrier plates, for example for brake linings, are economically improved and carrier plates are obtained, the mechanical/dynamical properties of which remain maintained even after the rough ground treatment. Furthermore, the rough ground is also to be inserted in case of sensitive carrier sheets without the strength properties of the friction lining carrier made of steel being modified after the rough ground treatment.

This aim is achieved by the characteristics characterized in the claims 1 and 2.

According to claim 1, the lining or functional body according to the invention consists of a carrier in form of a ground plate, for example a carrier plate or a carrier sheet, of a thin-walled rough ground carrier made of a metal sheet or of another appropriate material placed on the carrier, of a rough ground made of a support base sintered on the surface of the rough ground carrier which is turned away from the lining carrier, this support base being made of single moulded bodies with undercuts, recesses or the like which are positively and frictionally connected with the rough ground carrier, and of a functional block fixed on the rough ground carrier with the rough ground, this functional block being made of a friction material, a synthetic material, in particular of such a synthetic material which is not appropriate to get glued or to be applied in another manner, for example of a polymer or a polytetrafluor ethylene, whereby the rough ground carrier is fixed on the lining carrier by means of a welded, riveted or glued joint or other connecting procedures, such as engraving.

A friction lining according to the invention according to claim 2 consists of a friction lining carrier, of a thin-walled rough ground carrier placed on the friction lining carrier, of a rough ground made of a support base sintered on the surface which is turned away from the friction lining carrier, this support base being made of single moulded bodies with undercuts, recesses or the like which are positively and frictionally connected with the rough ground carrier, and of a friction lining block fixed on the rough ground carrier with the rough ground, whereby the rough ground carrier is fixed on the lining carrier by means of a welded, riveted or glued joint or other connecting procedures, such as engraving.

For this friction lining, the rough ground is not applied onto the actual friction lining carrier as for the known friction linings but on a separate rough ground carrier which is itself fixed with the friction lining carrier, i.e. the carrier plate or the carrier sheet. The rough ground carrier is preferably fixed on the friction lining carrier by means of a marginal welding running all around so that, on the one hand a fixed connection is obtained between the rough ground carrier and the friction lining carrier and on the other hand so that the penetration of moisture between the rough ground carrier and the friction lining carrier is avoided.

The procedure is so that a sheet is punched as a rough ground carrier according to the friction lining contour. This sheet as a rough ground carrier is then provided with the rough ground and the coated rough ground carrier is then welded, riveted or glued onto the actual friction lining carrier or fixed by means of other appropriate connecting procedures. For the welding, the laser beam welding is convenient since with this method the contour all around can be tightly welded and any number of welding spots can be arranged and distributed on the surface. When punching, the rough ground carrier can be bulged or moulded in order to obtain a higher strength. Eventually constituted hollow spaces can be filled before welding with a damping material.

Besides a welding all around for the fixing of the rough ground carrier with the friction lining carrier, the fixing can also take place by spot welding, whereby the spot welding preferably takes place on rough ground free surfaces.

For saving weight, according to a further characteristic of the invention, the friction lining carrier is provided at least with a window-type cut, whereby it is also possible within this context to weld the rough ground carrier with the friction lining carrier in the edge area of the window-type cut.

A filling or insulating material, for example made of a synthetic material or of ceramics for damping preferably temperatures or sound, can be placed in the window-type cut of the friction lining carrier. For increasing or improving the heat flow, a metallic filling or insulating material can be used, for example copper, wrought alloys made of light metal. It is also possible to place a filling of ceramics in the window-type cut of the friction lining carrier in order to maintain a high strength of the friction lining carrier in spite of a slight weight.

Moreover, the rough ground carrier can also consist of a thin sheet made of a composite material made of copper, coppered steel plate and aluminium fittings, whereby both components of the composite material are welded together by ultrasonic or laser welding. The rough ground is then applied onto the upperst component of the composite material.

In order to obtain a sufficient adherence between the friction lining block and the rough ground carrier with a simultaneous improvement of the protection against corrosion for the rough ground carrier as well as for the friction lining carrier, a metal electroplating, which consists of copper, silver, tin, cadmium, zinc, chromium or of another appropriate material, is applied before pressing-on the friction material onto the rough ground carrier, whereby a coating made of a high temperature resistent synthetic material such as, for example trifluorethylene, polytetrafluor ethylene, polysiloxane, silicone rubber can also be applied. The combined action of the rough ground, i.e. of the support base and the electroplating, results in a high protection against corrosion for the rough ground carrier, while the rough ground causes the bonding between the friction lining block and the rough ground carrier, since the electroplating follows the contour of the rough ground. An ecological method for manufacturing friction linings is created in this way.

Furthermore, it is proposed for a friction lining of the above mentioned type to provide that the support base constituting the rough ground consists of a material mixture made of a fraction (A) with a lower melting point and a fraction (B) with a higher melting point.

By using this mixture for constituting the support base in form of a structure made of positively and frictionally connected moulded elements moulded from the mixture which have undercuts, recesses and the like, it is possible that the surface of the structure has a completely bizarre and irregular structure, in the macrostructure as well as in the microstructure with respect to the single sintered particles so that each single moulded body sintered on the base has a bigger surface compared with a spherical surface, however without possessing a spherical configuration. A very high mechanical strength and a high temperature stability are thus achieved, what results in a high adhesive property and mounting safety of the friction lining block on the rough ground carrier. A further advantage results in that rough ground carriers made of a very thin steel can be used without the bonding between the friction lining block and the rough ground of the rough ground carrier or the rough ground carriers being impaired.

According to an advantageous embodiment, it is provided that the low melting point fraction (A) is a low melting metal such as tin, soft braze or quick solder or the like or a low melting alloy such as bronze, brass or the like and that the higher melting point fraction (B) is made of iron, sand, ceramics powder or the like, whereby the melting point of the higher melting point fraction (B) should lie under the melting point of the rough ground carrier. The rough ground carrier is made of steel, stainless steel, ceramics, aluminium or of other appropriate materials, whereby the actual friction lining carrier can also be configured in the same way. While the fraction (A) is low melting, the melting points of fraction (B) and also of the material of the rough ground carrier must be high; they can be different or also the same.

In spite of the electroplating, a direct force and heat transfer from the friction lining block to the sintered material base and thus to the rough ground carrier is possible. An additional connecting layer can preferably be omitted. A rust formation under the base and a begin of rust are additionally avoided in particular by using bronze so that the service life is improved and the corrodibility even under extreme environmental conditions is reduced.

Add to this that, due to the use of a composite material and in particular due to the used rough ground carrier, such a friction lining has optimal emergency running properties in the area of the sintered support base. Due to the bizarre structure of the surface in the brake disk contact area, a composite material made of a friction material and of a sintered material always has contact with the brake disk so that a braking can still be carried out with the residual friction material fraction. Simultaneously, there is a brake disk protection since, due to the used compound material, a destruction of the brake disk can be avoided. Thus, due to this structure, there is a high bonding and friction to the end so that emergency running properties do exist. A shearing-off of the rest lining is not possible because of the existing gearing between the bizarre structure of the surface of the structure with the friction lining block, whereby the safety is still additionally increased by the fact that a rust formation underneath can be safely avoided.

Furthermore, it has been proved that the used surface of the structure for the rough ground still has the additional advantage that there are no air inclusions between the friction lining block and the sintered support base, the undercuts and recesses being filled to a large extent by the friction material, whereby such inclusions make it possible for the materials to expand into the thus resulting caverns so that occuring heat tensions are reduced. Thus, there results an additional careful treatment of the friction lining and an improvement of the service life.

According to a preferred embodiment, the low melting fraction (A) consists of approximately 30% bronze and the high melting fraction (B) of a 70% iron powder, whereby the bronze used should have a percentage of 10% tin. By using such a mixture, the result is optimal with respect to all the properties wished such as the capacity of resistance to wear, silencing and protection against corrosion.

Preferably it is provided that the sintered support base is made of a ground layer which covers the rough ground carrier in the area of the friction material receiving surface on the whole surface or on part of the surface, this ground layer being made of single moulded elements positively and frictionallly connected with each other, which have undercuts, recesses or the like. The gripping elements can be configured as cylindrical columns, as truncated columns, as a true truncated cone or even in form of a pyramide in a triangular, square or polygonal basic surface, whereby the single gripping elements are arranged respectively at a distance from each other. The selection of the type of the gripping elements used depends on the wished properties of the friction lining. While a column-type configuration of the gripping elements results in the fact that the fraction between the support base material and the friction material remains relatively constant in the contact area even in case of increasing wear, when using other gripping elements the fraction of the support material increases so that a reduced wear can be achieved here so that the brake properties remain maintained even for a strong stress of the friction lining between two examinations.

For this embodiment, the bizarre structure of the sintered particles is particularly advantageous for the manufacturing of the rough ground, whereby each sintered compact has a bigger surface than a spherical surface, however without having the configuration of a sphere. Thus, a high mechanical strength and temperature stability and a high adhesive property are achieved.

In particular by using a rough ground carrier provided with a rough ground for receiving the friction lining block, it is achieved that for a rough rough manufacturing according to the methods known until now, the actual friction lining carrier is in no way impaired in its mechanical and chemical properties. Add to this that rough ground carriers made of a very thin material can be used and that the actual friction lining carrier can also have a lower thickness, since the total strength is obtained by the adhesion of the rough ground carrier with the friction lining carrier.

Further advantageous configurations and further developments of the invention are characterized in the subclaims.

The lining or functional body according to the invention can be used instead of the friction lining described above everywhere where a coating is to be applied onto a carrier, whereby the functional block can have any configuration and material composition.

### SHORT DESCRIPTION OF THE DRAWINGS

Embodiment examples of the invention will be explained below in more detail with reference to the attached drawings.

FIG. 1 shows a friction lining carrier with hammer-head configured end areas in a view onto the carrier side which carries the friction lining block.

FIG. 2 shows the friction lining carrier without friction lining block however with a rough ground carrier welded on it which carries the rough ground in a view onto the friction lining carrier which carries the rough ground carrier.

FIG. 3 shows the friction lining carrier with a rough ground carrier which carries a rough ground, the rough ground carrier being spot welded with the friction lining carrier, in a view onto the friction lining carrier which carries the rough ground carrier.

FIG. 4 shows an enlarged vertical section through a friction lining carrier with a rough ground carrier which carries a rough ground on this and with a friction lining block fixed thereon.

FIGS. 5A, 5B, 5C and 5D show views from above onto the friction lining carrier with various configured window-type cuts.

FIG. 6 shows an enlarged vertical section through a friction lining carrier provided with a window-type cut and with a rough ground carrier welded on the friction lining carrier.

FIG. 7 shows an enlarged vertical section through a friction lining carrier with several window-type cuts and with a rough ground carrier welded on the friction lining carrier in the area of the window-type cuts.

FIG. 8 shows an enlarged vertical section through a friction lining carrier with a window-type cut which is filled with an insulating material.

FIG. 9 shows an enlarged vertical section through a friction lining carrier with a window-type cut with a ceramics filling.

FIG. 10 shows an enlarged vertical section through a rough ground carrier made of a composite material.

FIG. 11 shows an enlarged vertical section through a friction lining carrier with a damping plate placed between the rough ground carrier and the friction lining carrier.

FIG. 12 shows an enlarged vertical section through a rough ground carrier with a support base placed-on in form of moulded bodies having undercuts or recesses.

FIG. 13 shows in a view from above a friction lining carrier with a rough ground carrier placed-on with a further embodiment of the support base placed on this as a rough ground.

FIG. 14 shows a vertical section according to line XIV-XIV in FIG. 13.

FIG. 15 shows in a section representation a further embodiment of the support base as a rough ground on the rough ground carrier.

### DETAILED DESCRIPTION OF THE INVENTION AND BEST WAY FOR CARRYING OUT THE INVENTION

In the embodiment shown in FIG. 4, a lining or a functional body 10′ is represented which consists of a carrier 11′ in form of a ground plate, for example a carrier plate or a carrier sheet, a thin-walled rough ground carrier 15′ made of a metal sheet or of another appropriate material placed on the carrier 11′, a rough ground 20′ made of a support base 21′ sintered on the surface 15′a of the rough ground carrier 15′ which is turned away from the lining carrier 11′, this support base consisting of single moulded bodies 22′ with undercuts, recesses or the like 23′ which are positively and frictionally connected with the rough ground carrier 15′, and a functional block 25′ fixed on the rough ground carrier 15′ with the rough ground 20′, for example of a friction material, a synthetic material, in particular a synthetic material, a metal powder/plastics mixture or of a hard or soft metal which are not appropriate to be glued together or to be applied in another manner, for example of a polymer or of a polytetrafluor ethyle known under the commercial name “TEFLON”, whereby the rough ground carrier 15′ is fixed on the lining carrier 11′ by means of a welded, riveted or glued connection 30′ or other connecting methods, such as engraving. For the lining or functional body, it is for example a friction lining 10 such as that which is described below.

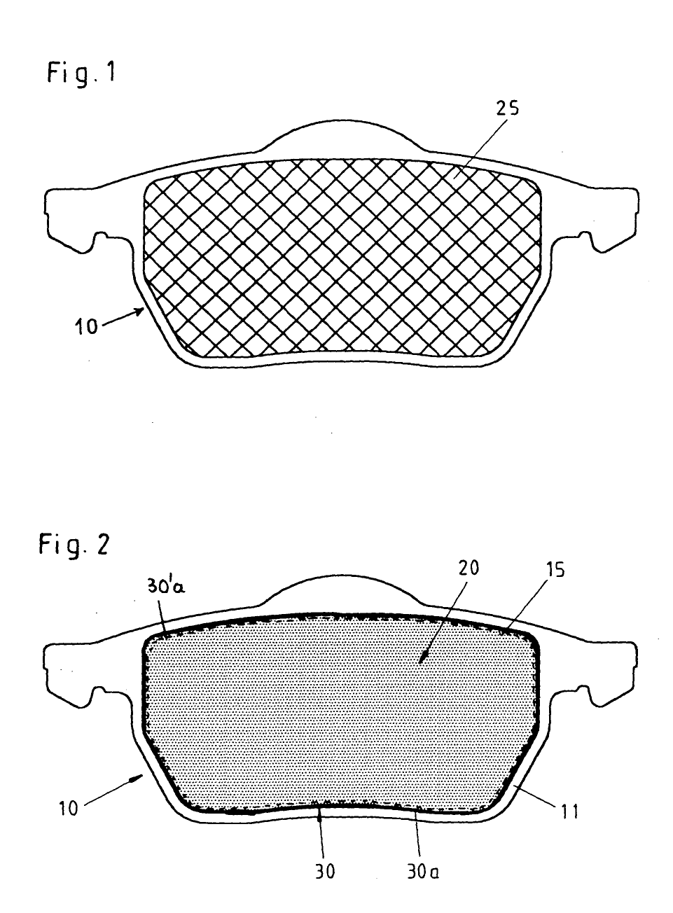

In FIGS. 1 to 4, a friction lining 10 is represented which consists of a friction lining carrier 11 made of steel or of other appropriate materials. The lining or friction lining carrier 11′, 11 consists of a flat or a two-dimensional or three-dimensional or one-piece or multipart carrier sheet. A thin-walled rough ground carrier 15 which is also made of a thin metallic material is placed on the friction lining carrier 11. This rough ground carrier 15 carries on its surface 15a turned away from the friction lining carrier 11 a sintered support base 21 of single moulded boudies 22 positively and frictionally connected with the rough ground carrier 15 with undercuts, recesses or the like 23. A friction lining block 25 which consists of a pressed friction material mixture is placed on the rough ground carrier 15 with is rough ground 20. This friction lining block 25 is pressed onto the rough ground 20 and is positively and frictionally connected with the rough ground carrier 15.

The rough ground carrier 15 is fixed on the friction lining carrier 11 by means of welded, riveted or glued connections 30, whereby other connecting means and connecting procedures can also be used.

The marginal welding 30a represents in FIG. 2 a contour welding, whereby the weld seam can be placed for example with an offset to the inside, starting from the outer edge, with up to 5 mm, what is indicated by 30′a. The weld seam can also be put to the outside onto the outer edge (FIG. 2).

Preferably the rough ground carrier 15 with its rough ground 20 and its friction lining block 25 is fixed on the friction lining carrier 11 by means of a marginal welding 30a running all around (FIG. 2). Due to this marginal welding 30a running all around, the rough ground carrier 15 is connected dampproof with the friction lining carrier 11. Accordingly, the friction lining block 25 is not placed directly on the friction lining carrier 11 but on the rough ground carrier 15 placed between the friction lining block and the friction lining carrier.

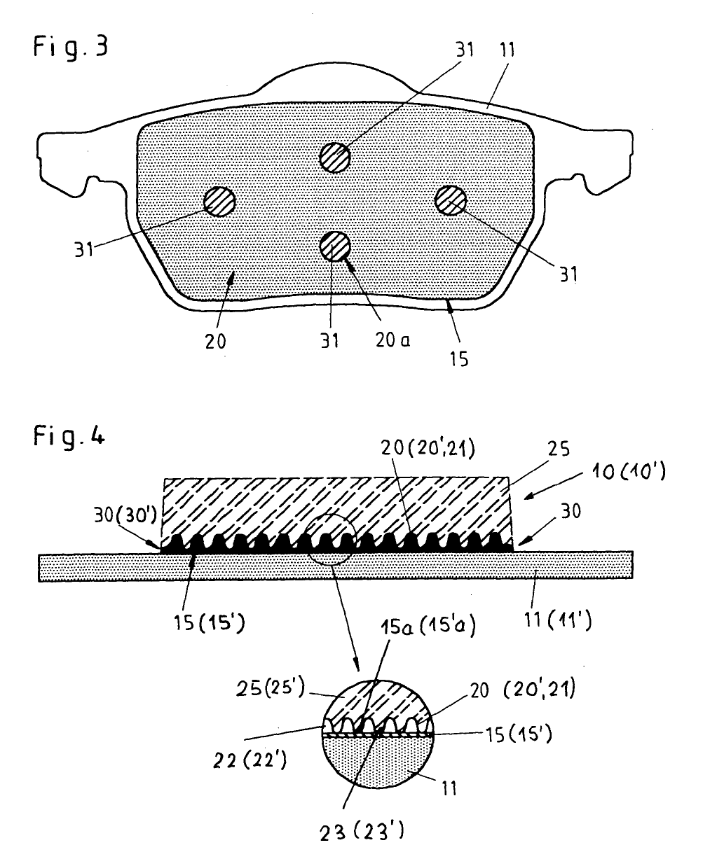

The marginal welding 30a for fixing the rough ground carrier 15 on the friction lining carrier 11 takes laces by laser beam welding. It is also possible to fix the rough ground carrier 15 on the friction lining carrier 11 by spot welding 31, whereby the spot welding 31 is made on rough ground free surfaces 20a (FIG. 3).

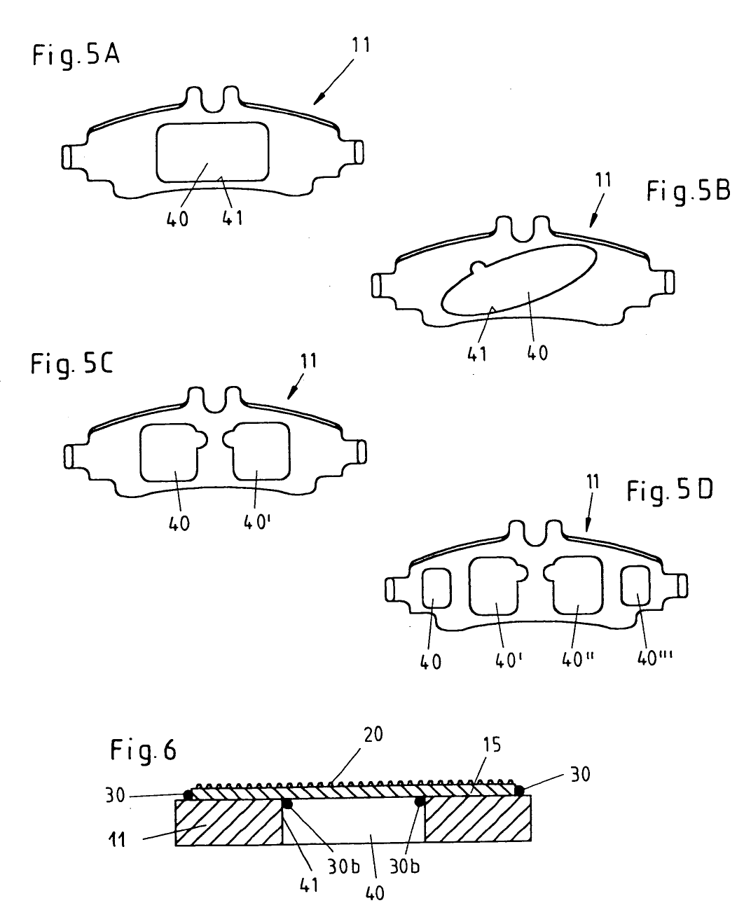

For the embodiments according to FIGS. 5A, 5B, 5C and 5D, the friction lining carrier 11 is provided with at least one window-type cut 40. This window-type cut 40 can have different configurations, according to FIGS. 5A and 5B. FIG. 5C shows a friction lining carrier 11 with two cuts 40, 40′ and FIG. 5D a friction lining carrier 11 with four window-type cuts 40, 40′, 40″, 40″′.

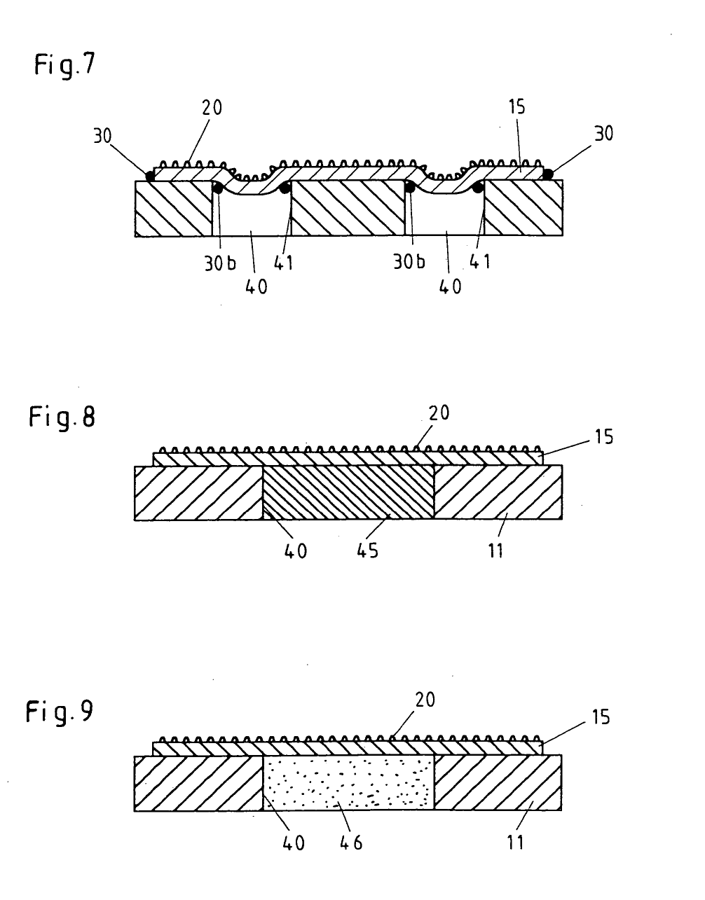

As FIG. 6 shows, besides the marginal welding 30a running all around for fixing the rough ground carrier 15 on the friction lining carrier 11, when using friction lining carriers with window-type cuts 40 it is possible to weld the rough ground carrier 15 still additionally in the edge area 41 of the cut 40 still additionally by means of a welded connection 30b. It is then possible, by using a very thin rough ground carrier 15, to deform this carrier when applying onto the friction lining carrier 11 in such a way that sections 15a of the rough ground carrier 15 are pressed into the window-type cuts 40, as represented in FIG. 7. An additional welding of the rough ground carrier 15 with the friction lining carrier 11 can then take place in the area of the inner wall surfaces of these window-type cuts. The rough ground carrier 15 can be fixed on the friction lining carrier 11 by means of a V-shaped welding, by welding on the outer edge or from below.

For the noise attenuation, for the friction lining 10 a friction lining carrier 11 with a window-type cut 40 can also be inserted, whereby the cut 40 is filled with a filling or insulating material 45 (FIG. 8). This insulating material 45 is preferably made of a synthetic material such as for example a plastic foam.

The window-type cut 40 in the friction lining carrier 11 can also be closed with a filling 46 of ceramics. This configuration has the advantage that in spite of a light weight of the friction lining carrier 11, this friction lining carrier has a high strength and inherent rigidity.

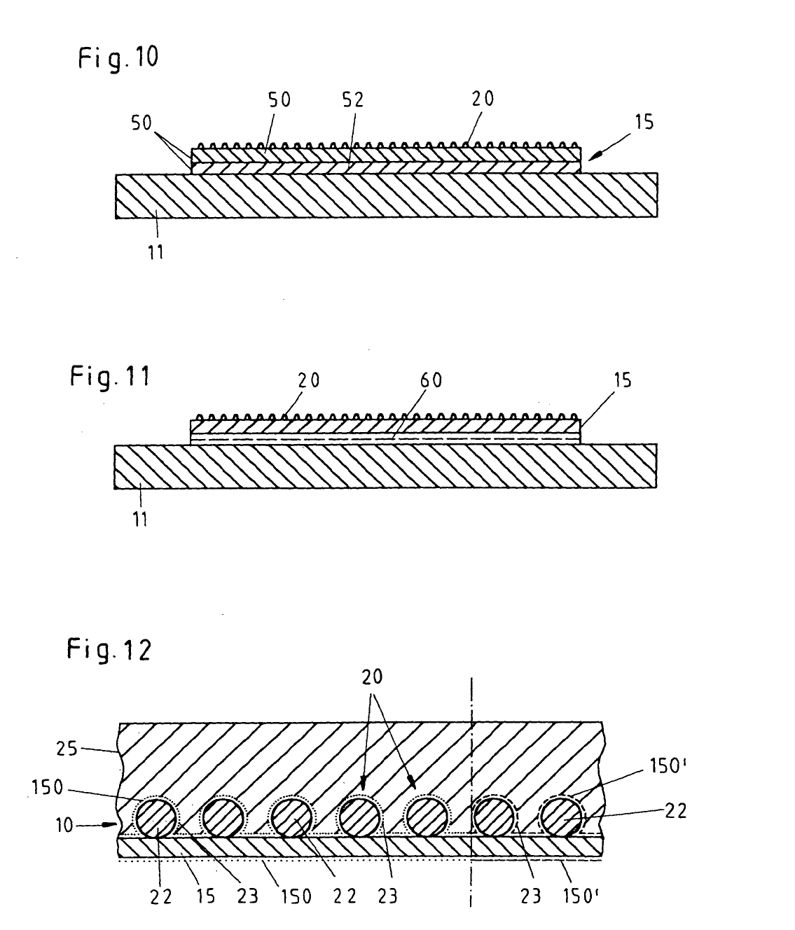

For the embodiment represented in FIG. 10, the rough ground carrier 15 consists of a thin sheet made of a composite material 50 of copper, coppered steel sheet on the one hand and aluminium on the other hand, whereby both components 51 and 52 of the composite material 50 are welded with each other by ultrasonic or laser welding. For this composite material 50, the upper component 51 consists of copper or coppered steel sheet and the lower component 52 of aluminium. The rough ground 20 is then applied onto the upperst component 51 of the composite material 50. With this configuration of the rough ground carrier 15 in form of a composite material 50, a rough ground carrier 15 with an extremely light weight is used by using aluminium.

According to FIG. 11, a damping plate or foil 60 made of rubber, a rubber-type synthetic material or a resilient synthetic material can be placed between the rough ground carrier 15 with the rough ground 20 and the friction lining carrier 11 so that a dampening of noise and vibrations takes place.

For the embodiment shown in FIG. 12, the support base 21 as a rough ground 20 on the rough ground carrier 15 consists of spherical moulded bodies 22 sintered onto the rough ground carrier 15 which form undercuts 23 in the fixing area. Preferably, an electroplating 150 of metal is applied onto the support base 21, this plating surrounding the single moulded bodies and being adapted to the contour formed by the moulded bodies, whereby the plating 150 also follows the course of the undercuts, recesses or the like 23 so that a closed plating is obtained; a good protection against corrosion is thus created for the rough ground carrier 15 and thus also for the friction lining carrier 11. The electroplating 150 can consist of copper, silver, tin, cadmium, zinc, nickel or of another appropriate material. The advantage brought by the partial plating consists in a precise dimensional stability with respect to the thickness of the plating. Furthermore, the contour of the support base 21 remains completely maintained so that there is a high positive frictional connection between the pressed friction lining block 25 and the rough ground 20 on the rough ground carrier 15.

Besides a plating 150 made of metallic materials, a synthetic material having the same properties can also be used as a coating. Such a coating is indicated by 150′ in FIG. 12. The synthetic materials which are also resistent at higher temperatures such as among others silicone rubber, trifluorethylene, polytetrafluor ethylene, polysiloxane and the like are particularly convenient as synthetic materials.

The friction material mixture is pressed onto the rough ground carrier 15 provided with the support base 21 with the aid of a corresponding moulded element in such a way that during the pressing procedure the friction material mixture flows into the gaps between the single moulded bodies and into the spaces which are formed by the undercuts, recesses and the like 23. In this way, an intimate connection is created between the deforming friction lining block 25 and the support base 21 which joggle and indent into each other. Thus, the friction material receiving surface on the rough ground 20 is filled up so that there does not result here any free surface or free space or only a very low number of free surfaces or free spaces.

According to a further embodiment according to the invention, the rough ground 20 on the rough ground carrier 15 can be formed by a wire grating which is placed on the rough ground carrier 15 by means of a welded, a soldered or another connection. With this configuration, a positive frictional connection with the friction lining block 25 is also obtained. This wire grating consists of rods with a circular, elliptic, triangular cross-section or with another geometrical cross-section form by configuring undercuts, recesses or the like.

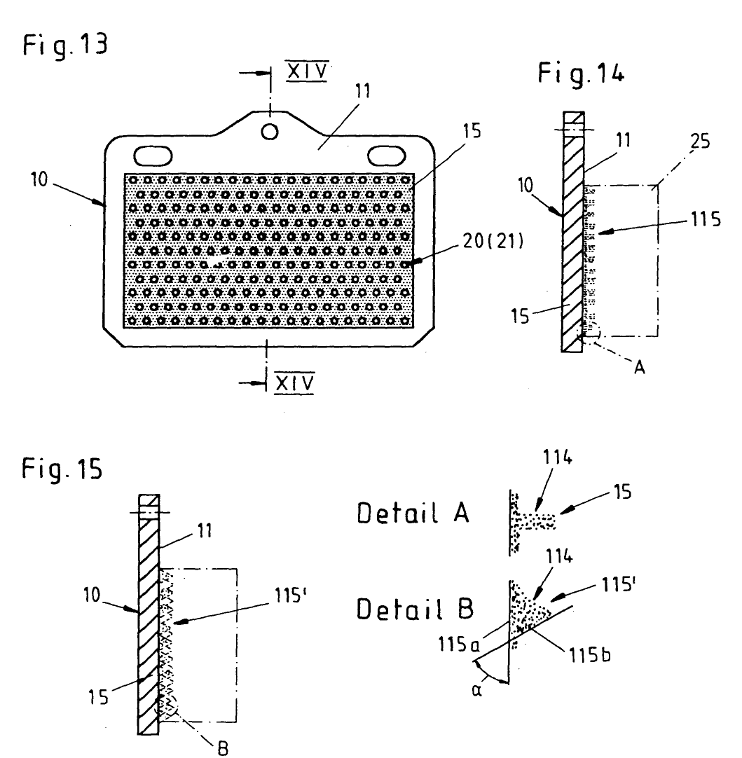

FIG. 3 shows a friction lining carrier 11 with a rough ground carrier 15 placed thereon with a rough ground 20 constituted on this. The rough ground 20 which is applied onto the rough ground carrier 15 for this embodiment according to FIG. 13 consists of a certain number of gripping elements 115 in form of cylindrical or truncted columns or as a truncated cone, as indicated in the detail A. In a macroobservation, the gripping elements 115 are columns, while an enlargement represented in more detail by means of the following figures shows that the gripping elements 115 per se are configured as bizarre structures with undercuts, recesses or the like 114.

In FIG. 15, a further embodiment is represented for which, contrary to FIG. 14, the gripping elements 115′ are configured as pyramides with a triangular, square or polygonal ground surface. In order to achieve here optimal support and wear properties, it is provided that the pyramide angle a between the pyramide ground surface 115a and the pyramide side 115b is approximately 600, as indicated in the detail B.

The friction lining according to the invention 10 has the advantage that, in spite of a temperature treatment, there is no material softening or any loss of strength with respect to the friction lining carrier 11. “Friction lining carrier” 11 designates the carrier sheet or the carrier plate which carries the rough ground carrier 15 with the rough ground 20 and the friction lining block 25 placed on this rough ground.

The invention is not exclusively limited to friction linings such as those described above and represented in the drawings. All possible composite bodies with the most different materials fall under lining or functional body.

1. Lining or functional body, characterized in that the lining (10) consists of
a.) a carrier (11′) in form of a ground plate, for example a carrier plate or a carrier sheet,
b.) a thin-walled rough ground carrier (15′) made of a metal sheet or of another appropriate material placed on the carrier (11′),
c.) a rough ground (20′) made of a support base (21′) sintered on the surface (15′a) of the rough ground carrier (15′) which is turned away from the lining carrier (11′), this support base being made of single moulded bodies (22′) with undercuts, recesses or the like (23′) which are positively and frictionally connected with the rough ground carrier (15′), and
d.) of a functional block (25′) fixed on the rough ground carrier (15′) with the rough ground (20′), this functional block being made of a friction material, a synthetic material, in particular of such a synthetic material which is not appropriate to be glued together or to be applied in another manner, for example of a polymer or teflon,
whereby the rough ground carrier (15′) is fixed on the lining carrier (11′) by means of a welded, riveted or glued joint (30′) or other connecting procedures, such as engraving.

2. Friction lining for disk brakes, in particular for high performance brakes for road and rail vehicles, made of a friction lining made of a block of a pressed friction material fixed on a friction lining carrier, characterized in that the friction lining (10) consists of
a.) a friction lining carrier (11) in form of a carrier plate or a carrier sheet,
b.) a thin-walled rough ground carrier (15) made of a metal sheet placed on the friction lining carrier (11),
c.) a rough ground (20) made of a support base (21) sintered on the surface (15a) which is turned away from the friction lining carrier (15), this support base being made of single moulded bodies (22) with undercuts, recesses or the like (23) which are positively and frictionally connected with the rough ground carrier (15), and
d.) of a friction lining block (25) fixed on the rough ground carrier (15) with the rough ground (20),
whereby the rough ground carrier (15) is fixed on the friction lining carrier (11) by means of a welded, a riveted or a glued joint (30).

3. A lining or functional body or friction lining according to any of the claims 1 and 2, characterized in
that the rough ground carrier (15) is fixed on the lining carrier (11) by means of a marginal welding (30a) running all around.

4. A lining or functional body or friction lining according to any of the claims 1 to 3, characterized in
that the marginal welding (30a) for fixing the rough ground carrier (15) on or at the lining carrier (11) is made by laser beam welding.

5. A lining or functional body or friction lining according to any of the claims 1 to 4, characterized in
that the rough ground carrier (15) is fixed on the lining carrier (11) by spot welding (31), whereby the spot welding (30a) preferably takes place on rough ground free surfaces (20a) of the rough ground (20).

6. A lining or functional body or friction lining according to any of the claims 1 to 5, characterized in
that the lining carrier (11) has at least one window-type cut (40).

7. A lining or functional body or friction lining according to claim 6, characterized in
that the rough ground carrier (15) is welded with the friction lining carrier (11) in the edge area (41) of the window-type cut (40) in the friction lining carrier (11).

8. A lining or functional body or friction lining according to any of the claims 5 or 6, characterized in
that an insulating material (45), for example made of a synthetic material, is placed in the window-type cut (40) of the lining carrier (11).

9. A lining or functional body or friction lining according to any of the claims 5 or 6, characterized in
that a filling (46) of ceramics is placed in the window-type cut (40) of the lining carrier (11).

10. A lining or functional body or friction lining according to any of the claims 1 to 9, characterized in
that the rough ground carrier (15) consists of a thin sheet, for example of steel.

11. A lining or functional body or friction lining according to any of the claims 1 to 9, characterized in
that the rough ground carrier (15) consists of a thin sheet of a composite material (50) made of copper or of coppered steel sheet and aluminium, whereby both components (51, 52) of the composite material (50) are welded together by ultrasonic or laser welding and that the rough ground (20) is applied or sintered onto the upperst component (51) of copper or coppered steel sheet of the composite material (50).

12. A lining or functional body or friction lining according to any of the claims 1 to 11, characterized in
that a damping plate or foil (60) made of rubber, a rubber-type synthetic material or a resilient synthetic material is placed between the rough ground carrier (15) and the lining carrier (11).

13. A lining or functional body or friction lining according to any of the claims 1 to 12, characterized in
that the single moulded bodies (22) of the rough ground (20) sintered onto the rough ground carrier (15) consist of single globules lined up side by side in a single layer or of other geometrical bodies made of bronze, brass, metal powder granulates or other appropriate materials.

14. A lining or functional body or friction lining according to any of the claims 1 to 12, characterized in
that a grating wire which is connected positively and frictionally with the functional body or with the friction lining block (25) is placed on the rough ground carrier (15) by means of a welded, a soldered or another joint.

15. A lining or functional body or friction lining according to claim 14, characterized in
that the wire grating consists of rods with a circular, elliptic, triangular cross-section or with another geometrical cross-section form by configuring undercuts, recesses or the like.

16. A lining or functional body or friction lining according to any of the claims 1 to 15, characterized in
that a metallic electroplating (150) which follows the contour of the rough ground is applied between the functional body or the friction lining block (25) and the rough ground (20) of the rough ground carrier (15) on the rough ground (20) as a protection against corrosion for the rough ground carrier (15), whereby the metallic electroplating (150) consists of copper, silver, tin, cadmium, zink, chrome or of another appropriate material.

17. A lining or functional body or friction lining according to any of the claims 1 to 15, characterized in
that a nonmetallic coating (150′) which follows the contour of the rough ground (20) of the support base (21) is applied between the functional body or the friction lining block (25) and the support base (21) sintered onto the rough ground carrier (15), for example of a high temperature resistent synthetic material as a protection against corrosion for the rough ground carrier (15).

18. A lining or functional body or friction lining according to any of the claims 1 to 17, characterized in
that the support base (21) consists of a material mixture made of a fraction (A) with a low melting point and a fraction (B) with a higher melting point.

19. A lining or functional body or friction lining according to claim 18, characterized in
that the low melting point fraction (A) is a low melting metal such as tin or the like or a low melting alloy such as bronze, brass or the like.

20. A lining or functional body or friction lining according to any of the claims 18 or 19, characterized in
that the higher melting fraction (B) consists of sand, ceramics powder or the like.

21. A lining or functional body or friction lining according to any of the claims 18 to 20, characterized in
that the melting point of the higher melting fraction (B) lies under the melting point of the rough ground carrier (15).

22. A lining or functional body or friction lining according to any of the claims 18 to 21, characterized in
that the low melting fraction (A) consists of approximately 30% bronze and the higher melting fraction (B) consists of approximately 70% iron powder.

23. A lining or functional body or friction lining according to claim 22, characterized in
that the bronze used has a percentage of 10% tin.

24. A lining or functional body or friction lining according to any of the claims 1 to 23, characterized in
that the rough ground (20) consists of gripping elements (115) placed at a distance from each other.

25. A lining or functional body or friction lining according to claim 24, characterized in
that each gripping element (115) is configured in form of a cylindrical column, a truncated column or as a truncated cone.

26. A lining or functional body or friction lining according to claim 24, characterized in
that each gripping element (115′) is configured in form of a pyramide or of a triangular, square or polygonal ground surface.

27. A lining or functional body or friction lining according to any of the claims 25 or 26, characterized in
that the cone or pyramide angle (a) between the ground surface and one side is approximately 60°.

28. A lining or functional. body or friction lining according to any of the claims 1 to 27, characterized in
that the support base (21) has a percentage (C) of carbon besides the fraction (A) and the fraction (B).

29. A lining or functional body or friction lining according to any of the claims 1 to 28, characterized in
that the lining carrier (11′) or the friction lining carrier (11) consists of a flat or two-dimensional or three-dimensional or one-piece or multipart carrier sheet.
